(19) United States
(12) Patent Application Publication
(10) Pub. No.: US 2016/0311193 A1
(43) Pub. Date: Oct. 27, 2016

(54) CUSTOMIZABLE SKIN FOR SWITCHES

(71) Applicant: Newict (M) Sdn Bhd, Penang (MY)

(72) Inventors: Kuam Hong Loh, Penang (MY); Hong Keng Lim, Penang (MY)

(21) Appl. No.: 15/067,409

(22) Filed: Mar. 11, 2016

(30) Foreign Application Priority Data
Apr. 21, 2015 (MY) PI 2015701276

(51) Int. Cl. B32B 3/26; B32B 7/08

(52) U.S. Cl. CPC B32B 3/266; B32B 7/08; B32B 2307/412; B32B 2307/414; B32B 2457/00

(57) ABSTRACT

The present invention relates to customizable skin for light switches, electrical, electronics, cable plugs, telephone plates, power outlets, combinations thereof and their equivalents. The present invention includes a front cover, in whole or in part, that is transparent, translucent or of lightly coloured material, and together with an attachment plate sandwiches at least one customizable skin or a superimposition of a plurality of customizable skins, whereby the front cover provide a viewing area to protect and to display an image on customizable skin or a superimposition of images formed from a plurality of customizable skins.

### TECHNICAL FIELD OF THE INVENTION

The present invention relates to customizable skin for light switches, electrical, electronics, cable plugs, telephone plates, power outlets, combinations thereof and their equivalents. The present invention comprises of a front cover, in whole or in part, that is transparent, translucent or of lightly coloured material, and together with an attachment plate sandwiching at least one customizable skin or a superimposition of a plurality of customizable skins, whereby said front cover provide a viewing area to protect and to display an image on said customizable skin or a superimposition of images formed from a plurality of said customizable skins.

### BACKGROUND OF THE INVENTION

In pursuing the ideals of giving users aesthetically pleasing switches for their homes, there are many known interchangeable covers for switches, telephone, electrical and electronic outlets in prior art. Users have a limited choice of colours or images preprinted on the cover that were provided by the manufacturers, whereby the colour and image options provided may not be what the users wanted. For customization, this process becomes complex, expensive and time consuming.

It would hence be extremely advantageous if the above shortcomings are alleviated by not having to change the cover but just change the image (also known as skin) behind a transparent or a translucent cover. It would be even more advantageous that these skins can be customized by the users themselves by designing and printing said customized skins by using the printers at their homes, anytime they want, of any colour or of any pictures they want at their own time.

### SUMMARY OF THE INVENTION

Accordingly, it is the primary aim of the present invention to provide a system to easily change the skin for switches.

It is yet another objective of the present invention to provide a simple method to customize the skin for switches.

In a preferred embodiment of the present invention there is provided, a customizable skin for switches without protrusion, including but not limited to touch sensitive switches, comprising of:

at least one front cover that can be formed of any suitable material, in whole or in part, that is transparent, translucent or lightly coloured including but not limited to glass or plastic;

at least one customizable skin that is made of any suitable material that can be painted, marked or printed using a printer including but not limited to plastic sheets or paper; and

at least one attachment plate whereby said front cover together with said attachment plate can sandwich and hold at least one said customizable skin or a plurality of said customizable skins that are superimpose on top of each other;

characterized in that said front cover consist of a display area and means to assemble to said attachment plate to sandwich and hold at least one said customizable skin and characterized in that said customizable skin can be either transparent, translucent or of a non see through material.

In a second embodiment of the present invention, there is provided, a customizable skin for mechanical switches comprising:

at least one front cover that may be formed of any suitable material, in whole or in part, that is transparent, translucent or lightly coloured including but not limited to glass or plastic, with suitable configurations and openings to match any fixtures with protrusion forming part of light switches, audio/video outlet, power outlet, telephone outlet, cable outlet, combinations thereof and their equivalents;

at least one customizable skin that is made of any suitable material that can be painted, marked or printed using a printer including but not limited to plastic sheets or paper, that may be of any suitable configurations and openings to match any fixture with protrusion forming part of light switches, audio/video outlet, power outlet, telephone outlet, cable outlet, combinations thereof and their equivalents,

at least one attachment plate that may be of any suitable configurations and openings to match any fixture with protrusion forming part of light switches, audio/video outlet, power outlet, telephone outlet, cable outlet, combinations thereof and their equivalents, whereby said front cover together with said attachment plate can sandwich and hold at least one said customizable skin or a plurality of said customizable skins that are superimpose on top of each other;

characterized in that said front cover consist of a display area and means to assembled to said attachment plate to sandwich and hold at least one said customizable skin and characterized in that said customizable skin can be either transparent, translucent or of non-see through material.

### BRIEF DESCRIPTION OF THE DRAWINGS

Other aspect of the present invention and their advantages will be discerned after studying the Detailed Description in conjunction with the accompanying drawings in which:

FIG. 1A illustrates an exploded view of one embodiment of a touch screen switch with a front cover, a customizable skin and an attachment plate.

FIG. 1B illustrates an assembled view of the touch screen switch in FIG. 1A.

FIG. 1C illustrates an exploded view of one embodiment of a touch screen switch with a front cover, a plurality of customizable skins superimposing on top of each other and an attachment plate.

FIG. 1D illustrates an assembled view of said switch in FIG. 1C.

FIG. 1E illustrates the back of said front cover, and FIG. 1F illustrates the front and bottomside of said attachment plate that in tandem with said front cover, illustrates a means to sandwich, display and protect said customizable skin or plurality of said customizable skins.

FIG. 2A illustrates an exploded view of one embodiment of a mechanical switch with a front cover and a customizable skin whereby both said front cover and said skin and said attachment plate are configured with an opening to match a protrusion forming part of said mechanical switch

FIG. 2B illustrates an assembled view of said mechanical switch in FIG. 2A.

FIG. 2C illustrates an exploded view of one embodiment of a mechanical switch with a front cover, a plurality of customizable skins superimposing on top of each other, whereby said front cover, said plurality of skins and said attachment plate are configured with an opening to match a protrusion forming part of said mechanical switch.

FIG. 2D illustrates an assembled view of the switch in FIG. 2C.

### DETAILED DESCRIPTION OF THE DRAWINGS

In the following detailed description, numerous specific details are set forth in order to provide a thorough understanding of the invention. However, it will be understood by those of ordinary skill in the art that the invention may be practised without these specific details. In other instances, well known methods, procedures and/or components have not been described in detail so as not to obscure the invention.

There are many known interchangeable cover for switches, telephone, electrical and electronic outlets in prior art where users have limited choice of preprinted colours or images that were provided by the manufacturers, whereby the colours and image options provided may not be what the users wanted. For customization, this process becomes complex, expensive and time consuming.

It would hence be extremely advantageous if the above shortcomings are alleviated by not having to change the cover but just change the image (also known as skin) behind a transparent or a translucent cover. It would be even more advantageous that these skins can be customized by the users themselves by designing, configuring, painting, marking or printing said customized skins of any colour or of any pictures and configured into any suitable shape and size of their choice.

Whereby, users can obtain said customizable skins as part of the basic system of a switch, purchase said customize skins separately or by printing their own customizable skins with their own designs.

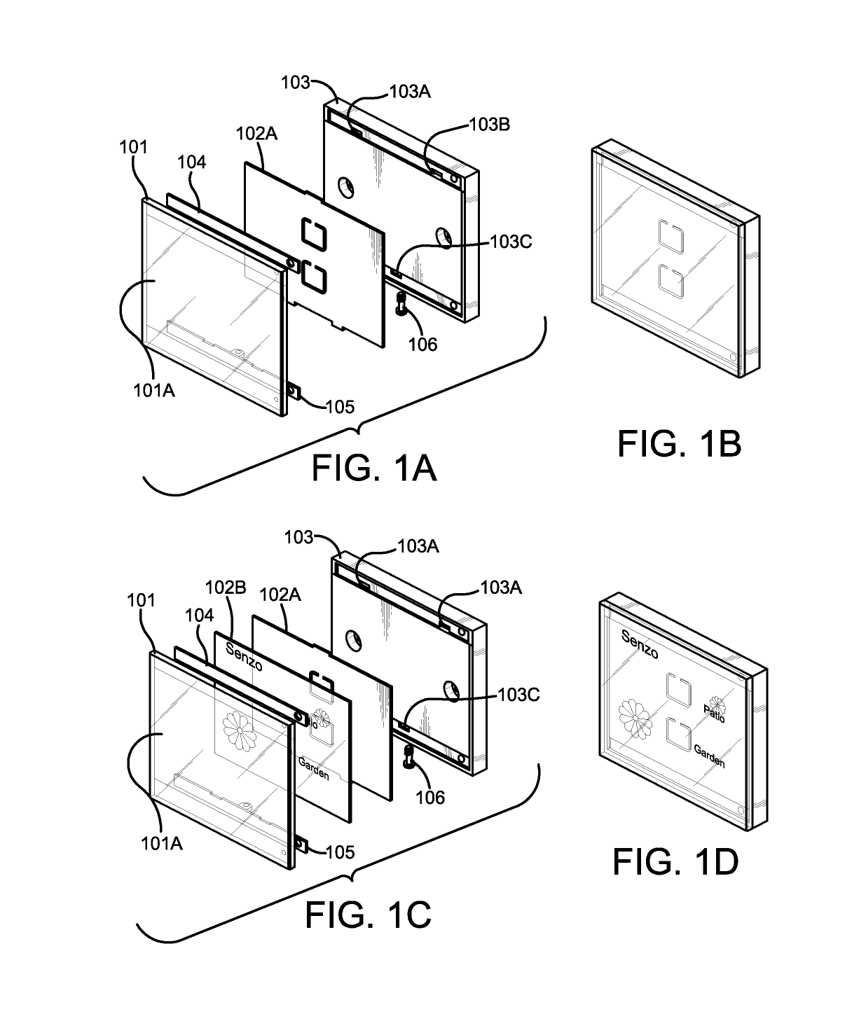

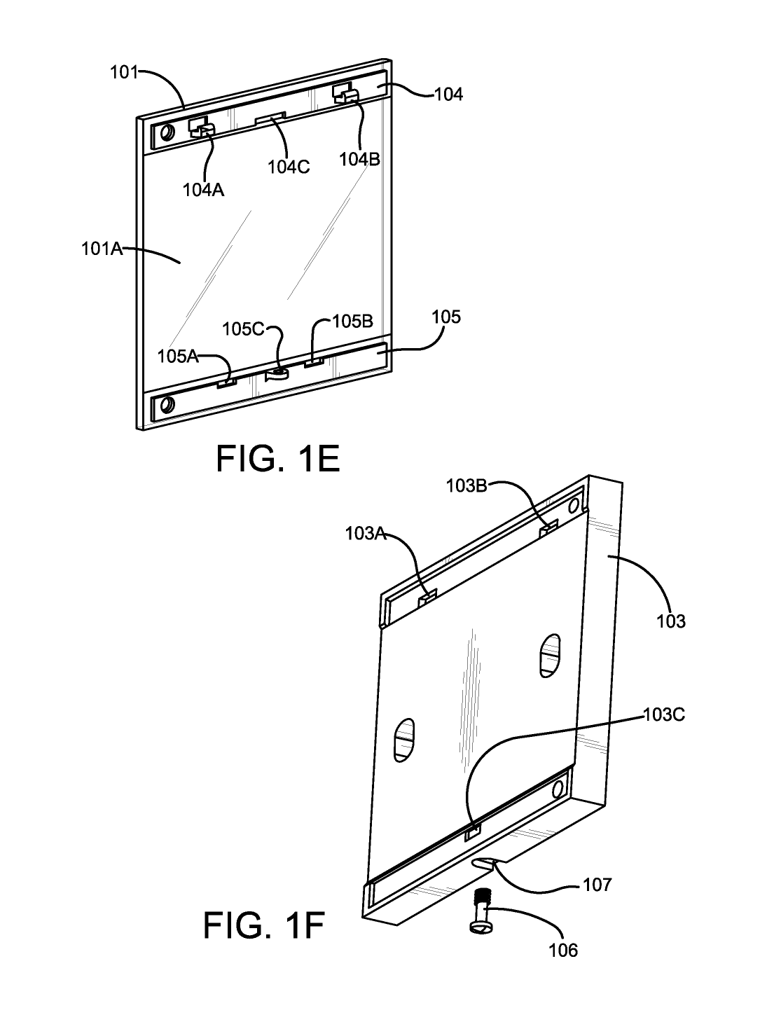

The solution mentioned above is illustrated in FIG. 1A which shows one embodiment of the present invention which comprises of at least one front cover (101) with a display area (101A), at least one customizable skin (102A) and at least one attachment plate (103) on the switch which is assembled into a complete unit (FIG. 1B).

The front cover can be formed of any suitable material, in whole or in part, that is transparent, translucent or lightly coloured including but not limited to glass or plastic.

The customizable skin may be made of any suitable material that is paintable, markable or printable using a printer including but not limited to plastic sheets or paper.

FIG. 1C shows one embodiment that comprises of at least one front cover (101) with a display area (101A), a first customizable skin (102A) and a second customizable transparent skin (102B) superimposing on top of said first customizable skin and at least one attachment plate (103) on the switch which is assembled into a complete unit (FIG. 1D), wherein a superimposition of images is formed from a plurality of said first customizable skin and said second customizable transparent skin.

FIG. 1E illustrates the back view of a front cover (101), with one of the means to assembled and sandwich said front cover and said customizable skin or plurality of said customizable skins to said attachment plate as illustrated in FIG. 1F. Said means to assemble and sandwich comprises of an upper plate (104) and a lower plate (105) that are affixed by means of adhesive, glue or epoxy to the front cover which further comprises of 2 hooks (104A and 104B) that mate with a set of upper apertures (103A and 103B) and a screw receptacle (105C) that mates to a lower aperture (103C) via a screw (106) that passes through an opening (107) that screwed thru said screw receptacle (105C) whereby joining said front cover (101) and said attachment plate (103) together. FIG. 1E also illustrates a display area (101A) to display image from said first customizable skin or a superimposition of images formed by a plurality of said customizable skins.

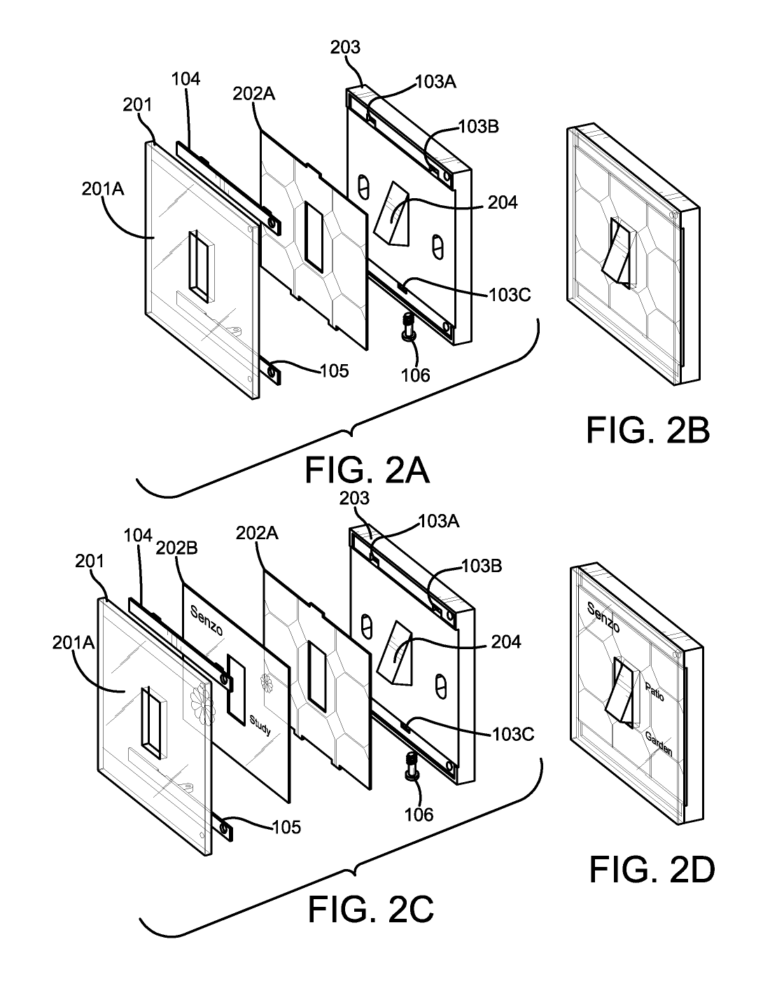

FIG. 2A shows one embodiment that comprises of a mechanical switch with a front cover (201) with a display area (201A) and a customizable skin (202A) whereby said front cover, said customizable skin and attachment plate (203) are each configured with an opening to match a protrusion (204) forming part of said mechanical switch which is assembled into a complete unit (FIG. 2B).

FIG. 2C shows one embodiment that comprises of a mechanical switch with a front cover (201) with a display area (201A), a first customizable skin (202A) and a second customizable transparent skin (202B) superimposing on top of said first customizable skin, whereby said front cover, said first customizable skin, said second customizable transparent skin and said attachment plate (203) are each configured with an opening to match a protrusion (204) forming part of said mechanical switch which is assembled into a complete unit (FIG. 2D), wherein a superimposition of images is formed from a plurality of said first customizable skin and said second customizable transparent skin.

A plurality of customizable skins may be superimposed on top of the other even though only 2 customizable skins are shown to superimposed in FIG. 1D and FIG. 2D

The terms “switches”, “plates” or “plugs” used herein should be understood to refer to light switches, electrical, electronics, audio video, cable plugs, telephone plates, any form of power outlets, combinations thereof and their equivalents used in homes and buildings.

The term “image” used herein should be understood to refer to pictures, photos, logos, variation in colours, outline and a variety of other designs. Said image can be painted, marked or printed using any type of printer onto one said customizable skin as a complete image or where said image is a superimposition of images formed from a plurality of said customizable skins.

The current invention of customizable skin for switches may further comprise of at least one alignment slot (105A, 105B and 104C) to help align said customizable skin or plurality of said customizable skins to the display area (101A) on the front cover (101)

While the preferred embodiment of the present invention and their advantages have been disclosed in the above Detailed Description, the invention is not limited thereto but only by the scope of the appended claims.

What is claimed is:

1. A customizable skin for switches, comprising:
at least one front cover that is transparent, translucent or lightly coloured;
at least one customizable skin that is either transparent, translucent or opaque material;
at least one attachment plate.

2. The customizable skin for switches as in claim 1 wherein said front cover has a display area to display said customizable skin.

3. The customizable skin for switches as in claim 2 wherein said display area can hold said customizable skin or a superimposition of a plurality of said customizable skins.

4. The customizable skin for switches as in claim 1 wherein an image can be painted, marked or printed onto said customizable skin.

5. The customizable skin for switches as claimed in claim 4 wherein said image can also be formed from a superimposition of images from a plurality of said customizable skins.

6. The customizable skin for switches as in claim 1 wherein said front cover has a means to join said front cover to said attachment plate to sandwich, display, and protect said customizable skin.

7. The customizable skin for switches as in claim 1 wherein said front cover further comprises suitable configurations and openings to match any protrusion forming part of electrical switches, audio/video outlet, power outlet, telephone outlet, cable outlet, combinations thereof and their equivalents.

8. The customizable skin for switches as in claim 1 wherein said customizable skin further comprises suitable configurations and openings to match any protrusion forming part of electrical switches, audio/video outlet, power outlet, telephone outlet, cable outlet, combinations thereof and their equivalents.

9. The customizable skin for switches as in claim 1 wherein said attachment plate further comprises suitable configurations and openings to match any protrusion forming part of electrical switches, audio/video outlet, power outlet, telephone outlet, cable outlet, combinations thereof and their equivalents.

10. A method of providing customizable skin for switches comprising the steps of:
(a) providing a front cover that is transparent, translucent or lightly coloured;
(b) providing a customizable skin that is either transparent, translucent or opaque;
(c) providing an attachment plate;
(d) providing a means to join said front cover to said attachment plate to sandwich, display, and protect said customizable skin or a plurality of said customizable skins between said front cover and said attachment plate.

11. The method of claim 10 wherein an image is painted, marked or printed onto said customizable skin.

12. The method as claimed in claim 11 wherein said image is formed from a superimposition of images from a plurality of said customizable skins.

13. The method of claim 10 wherein said front cover further comprises suitable configurations and openings to match any protrusion forming part of electrical switches, audio/video outlet, power outlet, telephone outlet, cable outlet, combinations thereof and their equivalents.

14. The method of claim 10 wherein said customizable skin further comprises suitable configurations and openings to match any protrusion forming part of electrical switches, audio/video outlet, power outlet, telephone outlet, cable outlet, combinations thereof and their equivalents.

15. The method of claim 10 wherein said attachment plate further comprises suitable configurations and openings to match any protrusion forming part of electrical switches, audio/video outlet, power outlet, telephone outlet, cable outlet, combinations thereof and their equivalents.
